(19) United States
(12) Patent Application Publication
(10) Pub. No.: US 2002/0061363 A1
(43) Pub. Date: May 23, 2002

(54) Method of making nanoshells

(76) Inventors: Nancy J. Halas, Houston, TX (US); Joseph B. Jackson, Houston, TX (US)

Correspondence Address: CONLEY ROSE & TAYON, P.C., P. O. BOX 3267, HOUSTON, TX, 77253-3267, US

(21) Appl. No.: 09/965,305

(22) Filed: Sep. 27, 2001

Related U.S. Application Data
(60) Provisional application No. 60/235,816, filed on Sep. 27, 2000.
(60) Provisional application No. 60/237,215, filed on Oct. 2, 2000.
(60) Provisional application No. 60/237,520, filed on Oct. 4, 2000.

(51) Int. Cl. B05D 7/00

(52) U.S. Cl. 427/217; 427/212

(57) ABSTRACT

A method of coating a complete metal layer onto a functionalized substrate particle to form a nanoshell is provided. The nanoshell preferably has a plasmon resonance with a maximum at a wavelenth between about 400 nanometers and about 2 microns. The method preferably includes functionalizing the substrate particle by reducing a precursor metal selected from among tin and titanium onto the subsrate particle. A metal, preferably selected from among gold, silver, nickel, iron, platinum, palladium, and copper, is then reduced onto the functionalized substrate particle. The method of reduction may include rapidly mixing a solution containing the substrate particle, ions of the metal, and a reducing agent. For some metals, a base may be rapidly mixed with the solution effective to coat the metal onto the functionalized substrate particle.

### CROSS-REFERENCE TO RELATED APPLICATIONS

The present application claims the benefit of 35 U.S.C. 111(b) provisional applications Serial Nos. 60/235,816 filed Sep. 27, 2000, and entitled “Silver Nanoshells”; 60/237,215 filed Oct. 2, 2000 and entitled “SnCl₂ Functionalization of Silica Particles for the Purpose of Making Metal Nanoshells”; 60/237,520 filed Oct. 4, 2000, and entitled “Nickel Nanoshells”, each hereby incorporated herein by reference.

### STATEMENT REGARDING FEDERALLY SPONSORED RESEARCH OR DEVELOPMENT

This work was supported by funding from the National Science Foundation Grant Number ECS-9801707, the Office of Naval Research Grant Number N00014-97-1-0217, and the National Aeronautics and Space Administration Grant Number NAG8-1467.

### FIELD OF THE INVENTION

The present invention relates generally to composite particles with sub-micron sizes having a metal coating layer adjacent a dielectric layer or core and methods of making thereof.

### BACKGROUND OF THE INVENTION

Particles able to absorb or scatter light of well-defined colors have been used in applications involving detection, absorption, or scattering of light, for example medical diagnostic imaging. Such particles are typically colloidal metal particles. The term colloidal conventionally refers to the size of the particles, generally denoting particles having a size between about 1 nanometer and about 1 micron.

Small particles made from certain metals that are in the size range of colloidal metal particles tend to have a particularly strong interaction with light, termed a resonance, with a maximum at a well-defined wavelength. Such metals include gold, silver, platinum, and, to a lesser extent, others of the transition metals. Light at the resonance wavelength excites particular collective modes of electrons termed plasma modes, in the metal. Hence the resonance is termed the plasmon resonance.

By selecting the metal material of a colloidal particle, it possible to vary the wavelength of the plasmon resonance. When the plasmon resonance involves the absorption of light, this gives a solution of absorbing particles a well-defined color, since color depends on the wavelength of light that is absorbed. Solid gold colloidal particles have a characteristic absorption with a maximum at 500-530 nanometers, giving a solution of these particles a characteristic red color. The small variation in the wavelength results from a particle size dependence of the plasmon resonance. Alternatively, solid silver colloidal particles have a characteristic absorption with a maximum at 390-420 nanometers, giving a solution of these particles a characteristic yellow color.

Using small particles of various metals, particles can be made that exhibit absorption or scattering of selected characteristic colors across a visible spectrum. However, a solid metal colloidal particle absorbing in the infrared is not known. Optical extinction, in particular absorption or scattering, in the infrared is desirable for imaging methods that operate in the infrared. Further, optical communications, such as long distance phone service that is transmitted over optical fibers, operate in the infrared.

It has been speculated since the 1950's that it would be theoretically possible to shift the plasmon resonance of a metal to longer wavelengths by coating that metal onto a core particle made of a different material. In particular, the full calculation of scattering from a sphere of arbitrary material was solved by Mie, as described in G. Mie, Ann. Phys. 24, 377 (1908). This solution was extended to concentric spheres of different materials, using simplifying assumptions regarding the dielectric properties of the materials, by Aden and Kerker, as described in A. L. Aden and M. Kerker, J. of Appl. Phys., 22, 10, 1242 (1951). The wavelength of the plasmon resonance would depend on the ratio of the thickness of the metal coating to the size, such as diameter of a sphere, of the core. In this manner, the plasmon resonance would be geometrically tunable, such as by varying the thickness of the coating layer. A disadvantage of this approach was its reliance on bulk dielectric properties of the materials. Thus, thin metal coatings, with a thickness less than the mean free path of electrons in the shell, were not described.

Despite the theoretical speculation, early efforts to confirm tunability of the plasmon resonance were unsuccessful due to the inability to make a particle having a metal coating on a dielectric core with sufficient precision so as to have well-defined geometrical properties. In these earlier methods, it was difficult to achieve one or both of monodispersity of the dielectric core and a well-defined controllable thickness of a metal coating, both desirable properties for tuning the plasmon resonance. Thus, attempts to produce particles having a plasmon resonance in keeping with theoretical predictions tended to result instead in solutions of those particles having broad, ill-defined absorption spectra. In many instances this was because the methods of making the particles failed to produce smooth uniform metal coatings.

However, one of the present inventors co-developed a novel method of making coated nanoparticles (particles with a size between about 1 nanometers and about 5 microns) that was successful in producing metal-coated particles having spectra having narrow well-defined spectra. Further, one of the present inventors co-discovered that improved agreement with theoretical modeling of the coated nanoparticles resulted from the incorporation in the theory of a non-bulk, size-dependent value of the electron mean free path. That is, improved agreement with theory was achieved by developing an improved theory applicable to thin metal coatings. Thus, in the improved theory a dependence of the width of the plasmon resonance on the thickness of the metal coating was described.

Complete nanoparticle coatings with gold have been demonstrated. Particles having at least one substantially uniform metal coating layer have been termed metal nanoshells. Nanoshell structures that exhibit structural tunability of optical resonance's from the visible into the infrared can currently be fabricated. Gold has the advantage of a strong plasmon resonance that can be tuned by varying the thickness of the coating. More generally, the resonance may be tuned by varying the either the core thickness or the thickness of the coating, in turn affecting the ratio of the two thickness of the coating to the thickness of the core. This ratio determines the wavelength of the plasmon resonance. A further advantage of gold-coated particles is that they have shown promise as materials with advantages in imaging and diagnostics. In particular, they have utility as band-pass optical filters, impeding the photo-oxidation of conjugated polymers, and in conjunction with surface enhanced Raman substrates. However, gold is a costly material and it would be desirable to have an alternative.

It was recently demonstrated that gold nanoshells are excellent Raman enhancers. The tunable plasmon resonance of nanoshells provides a degree of control over the local fields and enables the absorption of the substrate to be tuned to the resonance of the laser. An advantage of the nanoshell geometry is the increased control and precision of the Raman enhancement. This contrasts with the known SERS enhancement associated with a fractal network of aggregated colloid in solution. This enhancement depends on a more complicated geometry and is harder to achieve reliably. Further, due to the tunability of the plasmon resonance and the greater strength of the plasmon resonance for silver, makes silver nanoshells highly desirable for the application of SERS in the infrared.

Further, it would be useful to have a method of making small metal-coated particles with other advantages, such magnetism arising from the metal coating. Small magnetic particles have many applications. Such articles are used as toner in xerography, in ferrofluid vacuum seals, in nuclear magnetic resonance imaging as contrast agents, and in magnetic data storage. These magnetic particles are typically micron-sized in diameter or larger. The large size of these particles renders them less than satisfactory for several specialized applications.

If the magnetic particles were smaller, cost reduction by reducing the number of processing steps would be achieved in xerographic applications. In ferrofluid applications, the enhanced solubility due to carbon coating provided by smaller particles may be advantageous. In magnetic data storage, high density may be enhanced by using smaller particles. Moreover, in magnetic ink applications, the carbon coating and ability to disperse the nanoparticles in aqueous solutions may provide advantages for wetting and coating. Consequently, there is a potential need for sub-micron-sized metal, alloy, or metal carbide particles and a method for producing bulk amounts of these particles in a high yield process.

Previous methods of making metal nanoshells included embodiments in which substrate particles are functionalized by attaching a linker molecules to a substrate particle and attaching gold colloids to the linker molecules. The shell metal is then reduced from solution onto the gold colloid particles. This method has the disadvantages that the gold in the gold colloids in an expensive material. Further, this method has the disadvantage that after formation of the gold colloids in solution prior to attachment to the linker molecules, the gold colloid solution is preferably aged for at least two weeks.

Thus, there remains a need for a less costly, more rapid method of making nanoshells.

### SUMMARY OF THE INVENTION

In a preferred embodiment, the present invention provides a method of making a nanoshell that includes providing at least one substrate particle, treating the substrate particle with a solution of ions of a precursor metal selected from among tin and titanium so as to form a functionalized substrate particle, and forming a complete shell around the functionalized substrate particle by reducing a shell metal onto the functionalized substrate particle, the shell including the shell metal. The shell metal is preferably selected from among silver, gold, platinum, palladium, nickel, copper, and iron.

In another preferred embodiment, the present invention provides a method of making a nanoshell that includes providing a dielectric substrate, bonding atoms of a precursor metal selected from among tin and titanium to the dielectric layer to form a functionalized substrate; and forming a complete shell layer by contacting the functionalized substrate with a solution containing shell metal ions; and mixing a reducing agent with the solution. The shell metal is preferably selected from among silver, gold, platinum, palladium, nickel, copper, and iron.

In still another preferred embodiment, the present invention provides a method of making a nanoshell having a plasmon resonance that includes providing at least one substrate particle, reducing tin onto the substrate particle to form a functionalized substrate particle, reducing a shell metal onto the functionalized substrate particle effective to form a complete shell comprising the shell metal, where the shell metal is selected from among silver and gold.

In any of the above-described embodiments, the nanoshell may have a plasmon resonance with a maximum at a wavelength between about 400 nanometers and about 2000 nanometers, more preferably between about 500 nanometers and about 1500 nanometers, still more preferably between about 500 nanometers and about 1100 nanometers.

Still further, in any of the above-described embodiments, the method may further include attaching at least one Raman active molecule to the nanoshell. The nanoshell may enhance scattering of light by the Raman active molecule by an enhancement factor of at least about 50,000, more preferably at least about 1,000,000, still more preferably at least about 10¹².

Alternatively or in combination, in any of the above-described embodiments, the nanoshell may be magnetic.

A complete shell includes shell metal completely surrounding the substrate particle. Further, when the nanoshell has a plasmon resonance and the shell layer is complete, the particles' extinction maximum is related to its geometry, specifically, to the ratio of the thickness of an inner nonconducting layer to the thickness of an outer conducting layer.

Thus, the present invention comprises a combination of features and advantages which enable it to overcome various problems of prior methods. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a schematic drawing of the reaction of tin with a surface portion of a silica particle;

FIG. 2 is a) a TEM image of a particle before (left) and b) another TEM image after the rapid pH change in the silver deposition process of Example 5 (right);

FIG. 3 is a plot of UV/Vis (dashed) and Mie scattering theory (solid) of spectra for various core and shell sizes grown by the method of Example 5, where the theoretical and experimental dimensions of the nanoshell samples to which these spectra correspond are displayed in Table 1 ;FIG. 4 is a TEM image of a particle after the rapid pH change in the nickel deposition process of Example 6;

FIG. 5 is a plot of the extinction spectrum calculated from Mie scattering theory of various metal nanoshells, where the geometry is a core radius of 50 nm with a 10 nm shell;

FIG. 6 is a plot of the extinction spectrum calculated from Mie scattering theory for various metal nanoshells where the geometry is a core radius of 100 nm with a 10 nm shell; FIG. 7 is (a) TEM image of hydroquinone-deposited silver onto 120 nm diameter silica particle according to the method of Example 10 and (b) a plot of UV/Vis spectra of increasing deposited silver, where spectra 1 through 4 represent increasing amounts of silver deposition; FIG. 8 is (a) a plot of UV/Vis spectra of silica particle as more silver is deposited using NPG as the reducing agent according to the method of Example 11 and (b) TEM images corresponding to the silver silica particles in solution;

FIG. 9 is a plot of a Raman spectrum of 100 mM solution of p-MA in ethanol with the ethanol background subtracted, where the peak at 1598 cm⁻¹ correlates with the asymmetric stretching of the carbon ring, the peak at 1085 cm⁻¹ is thought to be an aromatic ring vibration having some C-S stretching character, and the 380 cm⁻¹ peak is currently unidentified (see text);

FIG. 10 is a plot of typical Raman spectra of pMA solution with silver nanoshells (red) and a silver nanoshell background (blue), where the nanoshells have an 79 nm silica core and ˜13 nm silver shell, and the three Stokes modes, 390 cm⁻¹, 1077 cm⁻¹, and 1590 cm⁻¹, all correspond to Raman active bending and stretching modes of the benzene ring of the pMA adsorbate molecule.

FIG. 11 is a plot of an average Raman spectra where the blue line represents the NPG silver/silica substrate solution and the red line represents substrate solution with p-MA;

FIG. 12 is a plot of a comparison of the calculated |E_{Raman}|⁴ for (i) 390 cm⁻¹, (ii) 1077 cm⁻¹ and (iii) 1590 cm⁻¹ pMA modes (solid lines) and the measured magnitude of the mode as a function of shell thickness for (a) 79 nm and (b) 65 nm silica cores, where all graphs are normalized to the maximum and the x-axis error bars represent the 1-2 nm deviation in shell thickness inherent in the production process and the y-axis error bars represent the standard deviation of the data points.

FIG. 13 is a TEM image of a tin functionalized particle obtained according to Example 17; and

FIG. 14 is a plot of a Uv/Visible spectrum of a silver-coated particle obtained according to Example 18.

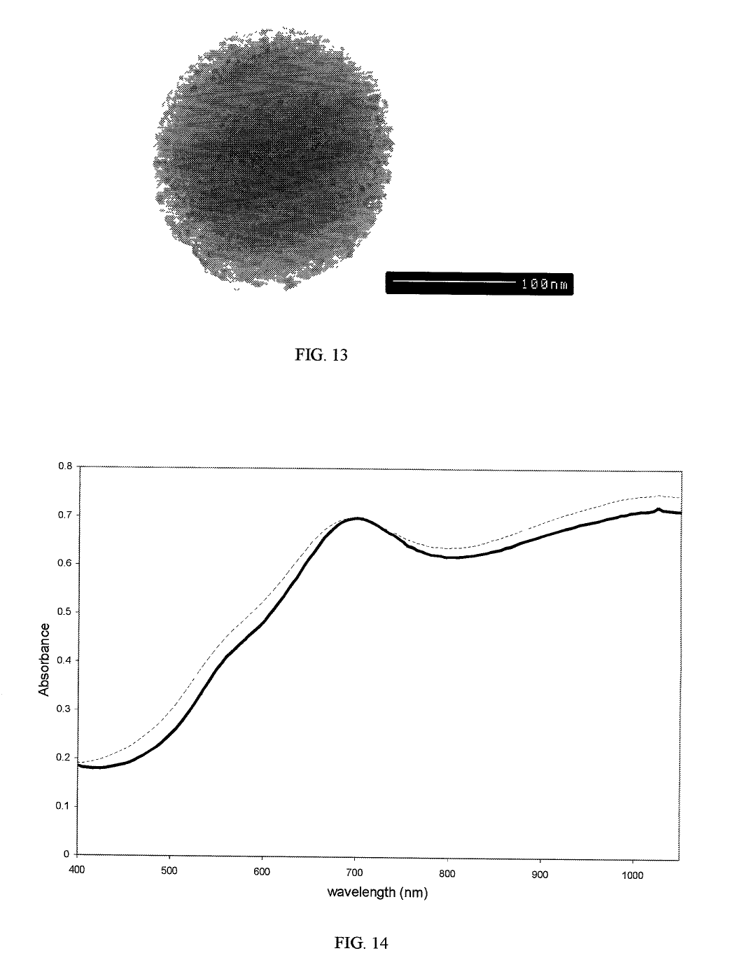

FIG. 15 is a TEM image of a gold-coated particle obtained according to Example 19.

### DETAILED DESCRIPTION OF THE PREFERRED EMBODIMENTS

Preparation of Silver Nanoshells

According to a preferred embodiment, the present invention includes a process for reducing silver to produce silver nanoshells. Silver nanoshells are made by creating the silica core, functionalizing it with tin, and then reducing silver onto the tin. More particularly, the fabrication of silver nanoshells is achieved by growing a silica core, prefunctionalizing its surface, attaching ultrasmall gold colloid, then reducing silver onto this seed structure until a shell of the desired thickness is formed.

Monodisperse silica cores are preferably grown using the Stöber method, described in Werner Stöber, Arthur Fink, and Ernst Bohn, J. Colloid and Interface Science 26, 62-69 (1968), entitled Controlled Growth of Monodisperse Silica Spheres in the Micron Size Range, hereby incorporated herein by reference. According to a preferred embodiment, tetraethylorthosilicate (TEOS), ammonium hydroxide (NH₄OH), and water are added to a glass beaker containing ethanol, and the mixture is stirred overnight. The size of the particles that result, herein termed Stöber particles, is dependent on the relative concentrations of the reactants.

The cores are preferably spherical particles between about 1 nanometers to about 5 microns in diameter, more preferably between about 1 nanometers and about 4 microns in diameter. A plurality of cores, for example in solution, is preferably monodisperse. Monodisperse particles are defined herein as particles that have a small variation in the distribution of particle sizes. For spherical particles the size is given by the particle diameter. The small variation is preferably quantified as the standard deviation. In a preferred embodiment, core particles are characterized by a distribution of diameters with a standard deviation of up to about 20%, more preferably about 10%.

According to a preferred embodiment of the present invention, core particles are functionalized with tin as described in more detail below. The functionalize particles are then preferably resuspended in a water. The solvent is preferably water. Alternatively, the solvent is ethanol. Centrifugation and resuspension are preferably repeated for a total number of cycles of preferably between 2 and 4.

According to a preferred embodiment of the present invention, the tin-functionalized silica particles are mixed with 0.15 mM solution of fresh silver nitrate and stirred vigorously. A small amount (typically 25-50 micro-liters) of 37% formaldehyde is added to begin the reduction of the silver ions onto the tin on the surface of the silica. This step is followed by the addition of 50 micro-liters of doubly distilled ammonium hydroxide. The “amounts” or “relative amounts” of tin-functionalized silica and silver nitrate dictate the core to shell ratio and hence the absorbance. Before further use, the nanoshell solution is preferably centrifuged to separate the nanoshells from solution and thus remove byproducts and any solid silver colloid that formed. The nanoshells are preferably resuspended in a solvent. The solvent is preferably water. Alternatively, the solvent is ethanol. Centrifugation and resuspension may be repeated for a total number of cycles of preferably between 1 and 2.

It will be understood that variations in the above-described method are contemplated. For example, it will be understood that the substrate particles are not limited to core particles. A substrate particle generally is any particle that includes at least an outer surface of silica or other substrate material. Further, substrate particles may have shapes other than spherical. In particular, although in preferred embodiments the core is spherical in shape, the core may have other shapes such as cubical, cylindrical, hemispherical, elliptical, and the like.

In some embodiments, alternative substrate materials may be used. The substrate material preferably is characterized by a smaller permittivity than the metal that is to be coated on it. Suitable materials include dielectric materials and semiconducting materials. Many dielectric materials are also semiconducting. In particular, suitable subtrate materials include silicon dioxide, titanium dioxide, polymethyl methacrylate, polystyrene, gold sulfide cadmium sulfide, cadmium sulfide, gallium arsenide, and the like. Further, suitable substrate materials include dendrimers.

It will be understood that methods of separation of a nanoshells and nanoshell intermediates from solution are not limited to centrifugation. It is contemplated that nanoparticle separation on a commercial scale may be achieved by any suitable conventional method. For example, for large scale separation cross-current filtration is preferred. Cross-current filtration conventionally includes a plurality of inner membranes contained within an outer wall. The inner membranes are preferably tubular, as is the outer wall. The inner membranes are preferably arranged in a bundle within the outer wall. The inner membranes include pores in their sides. Liquid contained between the outer wall and the inner membranes is maintained at a different pressure than liquid within the membranes. Thus there is a pressure differential across the pores. The solution to be separated in fed into adjacent ends of the inner membranes. A pump propels the solution into the ends. As the solution flows through the inner tubular members filtrate passes though the pores. The filtrate contains the solvent and byproducts. The retentate passes through the inner membranes to their opposite ends where it is collected. The retentate includes the particles. When cross-current filtration is used to achieve separation of nanoshells from solution the retentate includes the nanoshells. When cross-current filtration is used to achieve separation of nanoshell intermediates, such as tin-functionalized particles, the retentate includes the nanshell intermediate. On the lab bench scale, cross-current filtration has been observed to be successful for separating silver nanshells from solution and intermediates thereof. Further, it is believed that this method scales up to larger quantities without undue experimentation using conventional techniques.

It will be understood that alternative methods of a rapid rise in pH are contemplated. The pH preferably rises to a value of at least about 11, more preferably at least about 12, most preferably at least about 13. Before the rise, the pH of the solution is preferably about 6. The rise in pH is preferably accomplished with a time interval between about 0 and about 1.5 seconds, more preferably between about 0 and about 1 seconds, most preferably between about 0 and about 0.5 seconds.

The reduction of silver in this method is novel. In the last step, the addition of NH₄OH causes a rapid increase in the pH of the solution, resulting in the reduction of Ag⁺ ions and their deposition onto the nanoparticle surface, forming a silver shell. In contrast addition of formaldehyde alone, a technique that is capable of forming gold nanoshells, did not form silver nanoshells. The present inventors made the surprising discovery that, on a lab bench experimental scale, a rapid squirt of ammonium hydroxide resulting in formation of silver nanoshells. This is contrary to most reduction techniques. Most reduction techniques slow the reaction down in order to control the deposition rate. The present inventors believe that prior to this, there has not been a controlled reduction of silver ions in solution in a uniform manner of less than ˜30 nm. The addition of base speeds up the kinetics.

It has been observed by the present inventors that a gradual rise in pH resulting from a gradual addition and mixing in of base does not result in the formation of silver nanoshells. Rather the solution attains a dull gray color. While not wishing to be bound by the present interpretation, it is believed by the present inventors that the rapid rise in pH allows the pH to be changed to a high nanoshell-favorable value in a time shorter than the time it takes for nucleation of colloid in solution. On the other hand, if the pH were varied more slowly, silver colloid would form in solution before a pH were achieved that facilitated nanoshell formation.

In some embodiments, a rapid rise in pH is achieved by rapid mixing of a base with a solution containing metal ions, a reducing agent, and a functionalized substrate. Rapid mixing on a lab bench experimental scale was achieved in the examples described below by a rapid squirt of ammonium hydroxide from a pipet into a solution containing silver nitrate, formaldehyde, and gold-functionalized silica cores. The solution was stirred as the ammonium hydroxide was added. It is contemplated that rapid mixing on a commercial scale may be achieved by any suitable conventional method.

An advantage of silver nanoshells is the improved reliability of their performance as compared to gold nanoshells. It is believed that this may be due to improved control of the smoothness of the shell.

Functionalizing a Substrate using Tin

Tin functionalization may be used to functionalize a substrate for receipt of metal on the surface of the substrate. Thus, functionalization with gold colloid attached to a linker molecule attached to a substrate, as described above, may be replaced by tin functionalization, as described below. In this way, nanoshells each having a layer of a shell metal may be made by mixing tin ions and substrate particles in solution to form functionalized particles, followed by reduction of the shell metal onto the functionalized particles.

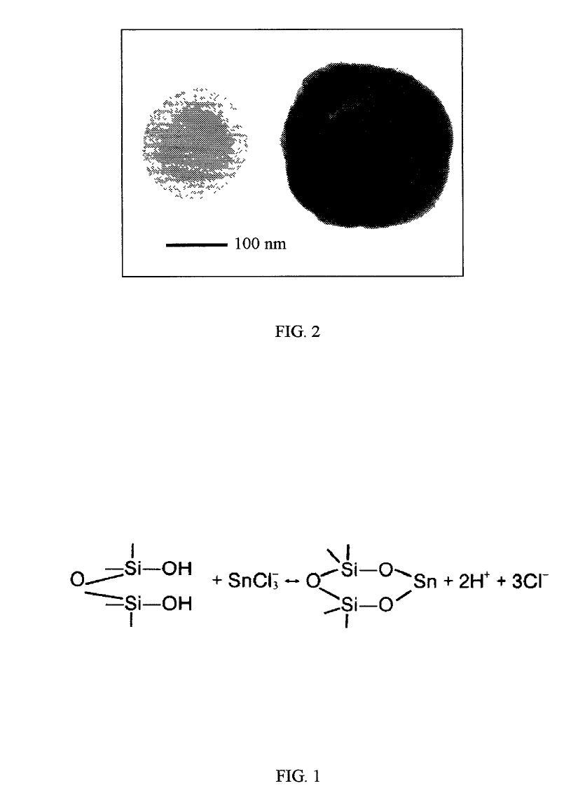

In one preferred embodiment, spherical silica particles are made using the Stöber method, as described above. A schematic of the reaction of tin with silica is shown in FIG. 1. After separation from a reactant solution, such as by centrifugation, the Stöber particles are redispersed in a first solvent and submerged in a solution of SnCl₂ in a second solvent. The first solvent may be water. Alternatively, and more preferably, the solvent is a methanol/water mixture, preferably 50% by volume methanol. Further, the second solvent may be water. Alternatively, and preferably the second solvent is a methanol/water mixture, preferably 50% by volume methanol. A solution of tin chloride in a methanol/water solvent preferably includes a surfactant, such as CF₃COOH. A method of tin functionalization using a methanol/water solvent is described, for example in Yoshio Kobayashi, et al. Chemical Materials 13, pp. 1630-1633 (2001), hereby incorporated herein by reference. By adding tin (II) chloride SnCl₂ and Stöber nanoparticles in a solvent, it is believed that tin atoms are deposited chemically onto the surface of the Stöber nanoparticles. Small tin precursor particles (<2 nm) form on the surface of the silica nanoparticle upon addition of more SnCl₂ to the solution. Presence of these tin particles have been observed by TEM, for example as described in Example 17 below.

After a period of time, such as at least 45 minutes, the tin-functionalized silica particles are separated from solution and redispersed in water. The separation from solution is achieved on the lab bench scale by centrifugation. Centrifugation has the advantage of removing any excess tin and preparing the tin-coated nanoparticles for further metal reduction. When the functionalized particles are redisbursed in water the pH tends to be about 3. The pH is preferably modified to at least 9. Modification of the pH has the advantage of achieving reaction conditions favorable for reduction of a shell metal, such as silver.

In a preferred embodiment, following preparation of the functionalized substrate particles for further reduction, preparation of nanoshells by reduction of a silver preferably proceeds as described above.

When excess solid silver nanoparticles are produced during the reaction they are preferably separated from the silver nanoshells, for example by centrifugation.

Tin is preferably used in excess of the amount needed to form a complete monolayer on a substrate particle. That is, tin is preferably added in an amount so that there are more tin ions that hydroxyl groups on the surface. This is believed to have the advantage of providing larger nucleation sites onto which the silver is reduced. The coverage of tin is preferably uniform. It has been observed that when water is used as the solvent for tin functionalization the tin tends to form small uniformly distributed clusters. Alternatively, it has been observed that when a methanol/water mixture is used the tin tends not to form clusters. If parts of the Stöber surface have a more dense coverage of tin, then silver tends to reduce faster onto those areas and compromises the uniformity of the shell thickness. This gives rise to large shell distributions and indistinguishable peaks when a solution of nanoshells formed from those substrates is examined by UV/Vis spectroscopy. The inventors have observed that use of a 50% by volume methanol/water mixture as the solvent for tin chloride in the tin functionalization results in more uniform nanoshells than when water is used as the solvent for the tin chloride.

An advantage of tin functionalization is the elimination of the use of a linker molecule, as well as the use of gold in the functionalization process of silica in order to grow nanoshells. The elimination of the use of gold in functionalizing a substrate reduces the cost of materials used in forming a nanoshell from the substrate. The elimination of the use of gold colloid also provides a less complex, faster method for producing metal nanoshells, as preparation of a gold colloid solution preferably includes an aging period of at least two weeks, whereas preparation of a tin ion solution preferably proceeds in the amount of time to dissolve tin chloride in solution.

A further advantage of functionalization of substrates, such as Stöber particles, with tin is the creation of an improved catalytic surface for the reduction of metal salts. In particular a substrate functionalized with tin has more catalytic sites for metal ions to reduce than a substrate functionalized with gold attached to a linker molecule.

In some embodiments, alternative metals to tin are used to functionalize a substrate particle. In particular, titanium has similar reduction properties to tin. Thus, it is contemplated that titanium could be used in replacement of tin for this process.

Preparation of Alternative Metal Nanoshells

It will be understood that the above-described embodiments of the present method of making silver nanoshells may be used to form nanoshells of any metal that has similarly rapid nucleation kinetics as silver. For example, this method may be used to form nickel nanoshells simply by substituting a nickel salt (e.g. nickel chloride) for the silver salt (e.g. silver nitrate). Further, it will be understood that other metals may have alternative useful properties to a strong plasmon resonance. For example, nickel is magnetic. Magnetic nanoparticles are potentially useful in such applications as disclosed above, including magnetic recording media, magnetic imaging, and the like.

Further, it is believed that this method may be used to form nanoshells of other materials for which a similar method that does not include the rapid rise in pH. Such methods are used to make gold nanoshells. However, the present inventors have found that such a method of reduction when applied to copper, adding formaldehyde to a solution containing a functionalized substrate and copper ions, excluding a rapid rise in pH resulting from rapid addition and mixing of ammonium hydroxide fails to form copper nanoshells. The present method is contemplated for the formation of copper nanoshells. Further, in some embodiments, alternative shell metals to silver are reduced onto a tin-functionalized substrate particle. Alternative metals include nickel and copper.

Further, a tin functionalized substrate may be used in a method of making a gold nanoshell as disclosed in co-pending U.S. application Ser. No. 09/038,377, filed Mar. 11, 1998, hereby incorporated herein by reference. This method, an embodiment of which is described more fully below, is similar to that described above for silver, except that mixing of a reducing agent with a solution containing functionalized substrates and gold ions is sufficient to reduce metallic gold onto the substrate particle, without any additional mixing of the solution with a base. It is contemplated that this reduction method may be used also for platinum, palladium and iron. These metals are believed to have similar nucleation kinetics to gold.

Preparation of a gold nanoshell from a tin functionalized substrate preferably proceeds as follows. After tin functionalization the solution tends to have a pH of 3. The pH is preferably brought up to at least a pH of 6 by the addition of NH₄OH. An aqueous solution of chloroauric acid and potassium carbonate is mixed with the particles and a reducing agent. Suitable reducing agents include sodium borohydride and formaldehyde. For example, in one preferred embodiment, a solution of 1.5 mL chloroauric acid (25 mM, aged 1 day), 25 mg potassium carbonate, and 100 mL water is then mixed with the particles and a reducing agent. The relative amounts of gold colloid-decorated Stöber particles and gold ion solution determine the core/shell ratio. Similar relative amounts are contemplated in a commercial scale process, while increasing the absolute amounts from the lab bench scale described above. It has been observed that as gold is reduced onto the gold colloid-decorated Stöber particles, gold islands begin to form on the Stöber surface, and as more gold is reduced these islands eventually coalesce into a complete gold shell.

Raman Scattering

A method of making a nanoshell may further include attaching at least one Raman active molecule to the nanoshell. The nanoshell may enhance scattering of light by the Raman active molecule by an enhancement factor of at least about 50,000, more preferably at least about 1,000,000, still more preferably at least about 10^{12.}

Since the internal geometry of a core-shell nanoparticle controls its far field electromagnetic response, it follows that the local electromagnetic field at the nanoshell surface is also controlled by its internal geometry. In Examples 15, and 16 below, we show that variation of the core diameter and shell layer thicknesses of a metal nanoshell tunes the local surface electromagnetic field of the nanoparticle in a controlled manner. The radial component of the electromagnetic field at the surface of the nanoparticle is monitored as a function of the nanoparticle's core and shell dimensions, by measuring the Raman scattering signal from a layer of nonresonant adsorbate molecules bound to the nanoparticle surface. The surface enhanced Raman scattering (SERS) response of the adsorbate molecules as a function of core and shell thickness is similar for all Stokes modes of the probe molecule, and obeys the predicted electromagnetic Raman response for a core-shell nanoparticle geometry in a quantitative manner. The maximum enhancements measured using this core-shell geometry correspond to a 10⁶ enhancement in solution under conditions of strong reabsorption of the Stokes emission by the nanoparticles: when this reabsorption is taken into account, enhancements of 10¹² are obtained.

The following examples are to be construed as illustrative, and not as constraining the scope of the present invention in any way whatsoever. All bright field images were acquired using a JEOL JEM-2010 transmission electron microscope (TEM) operating at 200 kV. The UV-Visible extinction spectra were obtained with a Hitachi U-2001 UV-Visible scanning spectrophotometer within the range 340 nm to 1050 nm.

### EXAMPLE 1

Monodisperse silica cores were grown using the Stöber method, described in Stöber, W.; Fink, A.; Bohn, E. J. Colloid Interface Sci. 1968, 26, 62, hereby incorporated herein by reference. This method is known to yield solutions of mondisperse silica particles in the size range of 80-500 nm, where the particle size is dependent on relative reactant concentrations. In particular, tetraethylorthosilicate (TEOS), ammonium hydroxide (NH40H), and water were added to a glass beaker containing ethanol, and the mixture was stirred overnight. The size of the Stöber particles was dependent on the relative concentrations of the reactants. For example, a solution of 1.5 ml TEOS, 3.5 ml NH40H (29%) and 45 mL ethanol typically yielded particles with a mean diameter of 210 nm. Following formation of the nanoparticles, the solution was centrifuged and the nanoparticles were redispersed several times in ethanol to remove any residual reactants.

### EXAMPLE 2

This is a comparative example. The surfaces of silica nanoparticle that were made by the method of Example 1 were functionalized with 3-minopropyltrimethoxysilane (APTMS). This reaction provided an amine-moiety coating for the exterior of the silica nanoparticles. The number and surface area of nanoparticles in solution was estimated using the amount of TEOS added, the density of Stöber particles (2.0 g/cm³), and the size of the particles as determined by transmission electron microscopy (TEM). This information was used to determine how much of a silane, 3-aminopropyltrimethoxysilane (APTMS) would be required to coat the nanoparticle surface with several monolayers, assuming 0.4 nm² per silane molecule.

This amount of APTMS was then added to the Stöber particle solution and the mixture was boiled for 3 hours, during which time any evaporated ethanol is replaced. Boiling the mixture promoted condensation of the methoxy functional groups of the APTMS with the Stöber nanoparticle surface, and left the terminal amine group of the APTMS molecules coating the exterior of the nanoparticle. The solution was then centrifuged and redispersed in ethanol several more times to remove any residual reactants.

### EXAMPLE 3

This is a comparative example. Ultrasmall gold colloid (1-3 nm) was synthesized using a recipe disclosed in D. G. Duff and A. Baiker, Langmuir 9, 2301 (1993), hereby incorporated herein by reference. This entailed a solution of 45 mL of water, 1.5 mL of 29.7 mM HAuCl4, 300 uL of 1M NaOH and 1 mL (1.2 mL aqueous solution diluted to 10 mL with water) of tetrakishydroxymethylphosphoniumchloride (THPC). This solution was then aged for about 14 days under refrigeration. After this time the gold solution was concentrated to 2 ml using a rotovap.

### EXAMPLE 4

This is a comparative example. The amine-functionalized silica particles obtained as in Example 2 were added to a solution of ultrasmall gold colloid (1-3 nm) obtained as in Example 3. Typically, a gold colloid monolayer on the silane terminated substrates covered ˜30% of the exposed surface area (as determined by TEM). The total surface area of the APTMS functionalized Stöber nanoparticles was calculated to ensure this amount of coverage and the functionalized Stöber nanoparticles are added to the THPC gold. The solution was then shaken and allowed to sit for at least 8 hours. After the gold colloid attachment the solution was then centrifuged and redispersed in water. This resulted in the gold colloids coating the silica nanoparticles with a surface coverage of nominally 25 percent. Small gold colloid was chosen instead of silver because of the simplicity and reliability of synthesis of gold colloid in this size regime. The geld colloid bonds stably to the amine-terminated surface and provides nucleation sites for the chemical deposition of silver.

### EXAMPLE 5

Gold-functionalized silica particles obtained as in Example 4 were mixed with 0.5 mM solution of fresh silver nitrate (AgNO₃) and stirred vigorously. A small amount (50 μL) of 37% formaldehyde was added to begin the reduction of the silver onto the gold particles on the surface of the silica particle. At this point the solution was colorless. This step was followed by the addition of 50 μL doubly distilled concentrated ammonium hydroxide (NH40H). The NH₄OH causes a rapid increase in the pH of the solution resulting in the reduction of Ag⁺ ions and their deposition onto the nanoparticle surface forming a silver shell. At this point the solution was blue, indicating the formation of a silver shell.

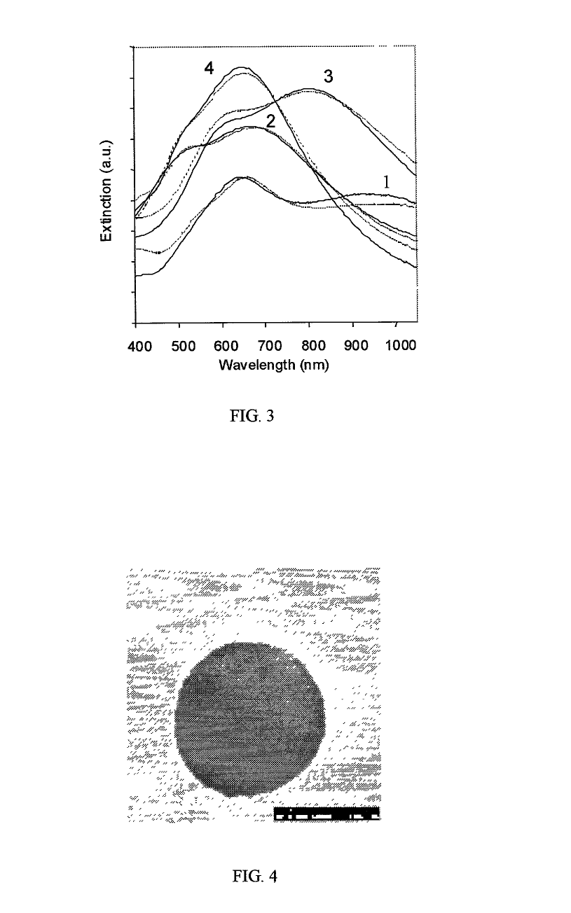

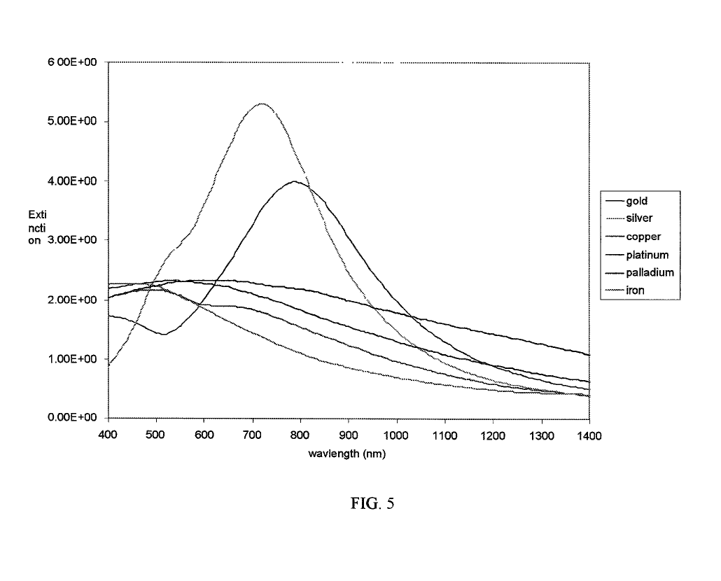

A TEM image of a nanoparticle before and after this rapid pH change is shown in FIG. 2. This method produces smooth, complete silver nanoshells and allows for tunability of the plasmon resonance through the visible and into the infrared wavelengths. UV/Visible extinction spectra for a few representative core/shell ratios are shown as broken lines in FIG. 3.

### EXAMPLE 6

This is a comparative example. The plasmon-derived extinction spectra of silver nanoshells obtained as in Example 5 was compared to far field extinction spectra calculated using Mie scattering theory, represented by the solid lines in FIG. 3. Mie solved the problem of light scattering from a solid sphere, as described in Mie, G. Ann. Phys. 1908, 24, 377, hereby incorporated herein by reference. Aden and Kerker expanded this solution for the case of a core-shell particle, as disclosed in Aden, A. L.; Kerker, M. J. App. Phys. 1951, 22, 1242, hereby incorporated herein by reference. The calculated spectra shown here follow a series solution developed by Sarkar, as described in Sarkar, D.; Halas, N. J. Phys. Rev. 1997, 56, 1102, hereby incorporated herein by reference. Modifications in the dielectric function of the metal due to increased electron scattering in the confined shell geometry were included in the calculation. These modifications are relevant for any metallic nanostructure with at least one spatial dimension smaller than the bulk electron mean free path in the metal. For silver, the bulk electron mean free path is 55 nm.

The core and shell dimensions for silver nanoshells corresponding to four different sizes obtained experimentally from the TEM images of those nanostructures are compared to the dimensions used in the theoretical spectra, and are shown in Table 1. In the calculations, the core size and shell thickness variations were assumed to be Gaussian.

Agreement between the theoretically and experimentally obtained dimensions for these nanostructures is excellent. The small discrepancies that occurred between the calculated and the measured spectra could be due to the presence of small gold colloid in the nanoshell and non-uniform size distributions of the nanoshell. In conclusion, the nanostructures grown by this method, and viewed in this Example, were indeed uniform, layered concentric sphere structures.

### Table 1.

| | Calculated | | | Experimental | |
|---|---|---|---|---|---|
| | | | Total | | Total |
| | | | Radius | | Radius |
| Spectrum | Core (nm) | Shell (nm) | (nm) | Core (nm) | (nm) |
| 1 | 92 ± 4 | 15 ± 2 | 107 ± 6 | 89 ± 7 | 107 ± 8 |
| 2 | 49 ± 6 | 16 ± 1 | 65 ± 7 | 49 ± 7 | 65 ± 8 |
| 3 | 65 ± 5 | 11 ± 1 | 76 ± 6 | 66 ± 7 | 76 ± 8 |
| 4 | 42 ± 5 | 18 ± 1 | 60 ± 6 | 42 ± 7 | 60 ± 8 |

EXAMPLE 7

Gold-decorated silica particles obtained as in Example 4 were mixed with 8 ml of a 0.541 M solution of fresh nickel chloride (NiCl₂·6H₂O) and stirred vigorously. 50 μL of 37% formaldehyde was added to begin the reduction of the silver onto the gold particles on the surface of the silica particle. At this point the solution was colorless. This step was followed by the addition of 50 μL doubly distilled concentrated ammonium hydroxide (NH₄OH). The NH₄OH causes a rapid increase in the pH of the solution resulting in the reduction of Ni²⁺ ions and their deposition onto the nanoparticle surface forming a silver shell. The solution, upon centrifugation, was a very pale light blue.

A TEM image of a nanoparticle after this rapid pH change is shown in FIG. 4. This method produces smooth, complete nickel nanoshells.

### EXAMPLE 8

Alternative Metal Nanoshells

Standard Reduction Potential

The potential for the use of various metals was investigated by examining the reduction potential of other metals and the oxidation potential of several reducing agents. Reduction potentials for various metals of interest in making shells are given in Table 2. These values were obtained from A. J. Bard, R. Parsons, and J. Jordan Standard Potentials in Aqueous Solutions (Dekker, New York, 1985). Oxidation potentials for several reducing agents are given in Table 3. These values were obtained from G. O. Mallory and J. B. Hajdu, Electroless Plating: Fundamentals & Applications (American Electroplaters and Surface Finishers Soc., Florida, 1990.

TABLE 2

| Standard Reduction Potentials [30] | Eo/V |
|---|---|
| Cu + 2(aq) + 2e- → Cu(c) | 0.340 |
| Cu + (aq) + e- → Cu(c) | 0.159 |
| AgNO2(c) + e- → Ag(c) + NO2— (aq) | 0.546 |
| Ag + (aq) + e- → Ag(c) | 0.7991 |
| Au + + e- → Au | 1.83 |
| Au + 3 + 3e- → Au | 1.52 |
| Au + 3 + 2e- → Au + | 1.401 |
| Pt + 2(aq) + 2e- → Pt(s) | 1.188 |
| Pt + 4(aq) + 4e- → Pt(s) | 1.150 |
| Ni + 2 + 2e- → Ni | −0.232 |
| Pd + 2(aq) + 2e- → Pd(s) | 0.915 |
| Fe + 3(aq) + 3e- → Fe | −0.04 |
| Fe + 2(aq) + 2e- → Fe(aq) | −0.44 |
| Fe + 3 + 1e- → Fe + 2 | 0.771 |

TABLE 3

| Standard Oxidation Potential of Reducing | |
|---|---|
| Agents | Eo/V |
| BH4— + 3H20 → B(OH)3 + 7H + + 8e- | 0.481 |
| HCHO + H20 → HCOOH + 2H + + 2e- | 0.056 |
| BH4— + 8OH— → B(OH)4— + 4H20 + 8e- (basic) | 1.24 |
| HCHO + 3OH— → HCOO— + 2H2 + 2e- | 1.070 |
| (pH = 14) | |
| H2PO2— + H20 → H2PO3— + 2H + + 2e- | 0.50 |
| N2H4 + 4OH— → N2 + 4H2O + 4e- (basic) | 1.16 |

If the sum of half reactions (e.g. reduction half reaction and oxidation half reaction) yields a positive potential, the reaction will proceed. For example, for the reduction of gold with sodium borohydride, the first two of the following reactions sum to give the third of the following reactions:

| | |
|---|---|
| 8Au⁺³ + 24e- → 8Au | E° = 1.52 V |
| 3BH₄⁻ + 9H₂O ⇄ 3B(OH)₃ + 21H⁺ + 24e⁻ | E° = 0.481 V |
| 8Au⁺³ + 3BH₄^{- + 9H}₂O ⇄ 8Au + 3B(OH)₃ + 21H⁺ | E° = 2.001 V |

It will be understood that there are several factors that can influence the redox potential. The pH of the solution, the solvent used in the reaction, and any residual ions in solution can effect the reduction potential of the metals or reducing agent. All of the potentials cited here are at standard temperature and pressure, with neutral pH unless otherwise noted.

These tables demonstrate the possibility for the production of nickel, copper, platinum, palladium, and iron nanoshells based on the favorable reduction potentials of these metals with certain reducing agents. The limitations on shell growth are governed by the kinetics involved. Standard reduction recipes consist of a metal salt, chemical stabilizer, and reducing agent. The chemical stabilizer controls the kinetics of the reaction and hence controls shell growth, therefore stabilizer selection is paramount.

Mie Scattering Theory

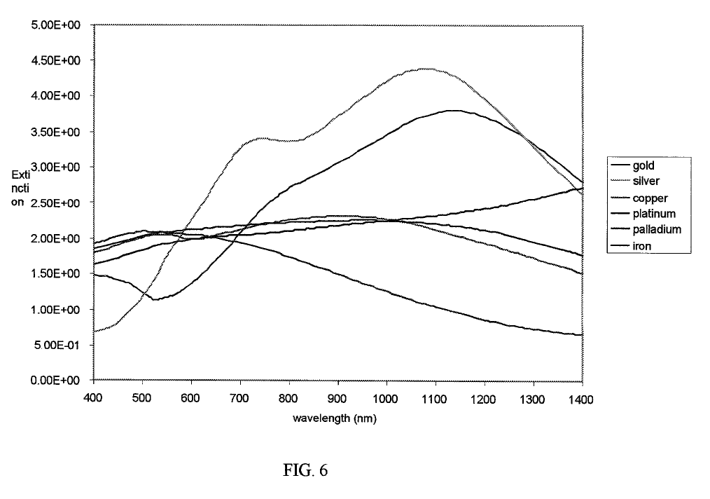

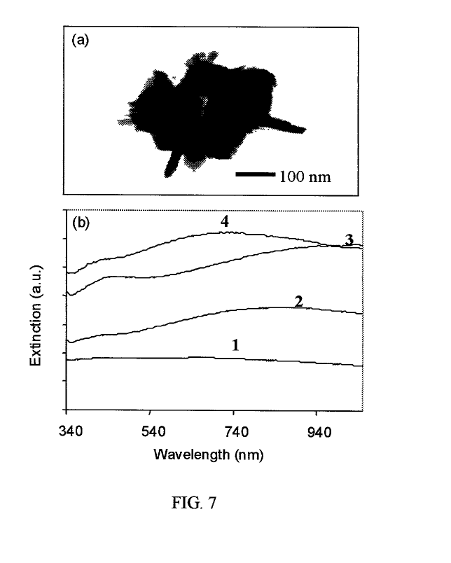

Silver and gold are optically the most active of these metals; however, Mie scattering theory can still be used to predict the optical absorption of other metal nanoshells. In FIGS. 5 and 6 the optical extinctions are calculated for these other metals for a core size of radius 50 nm and 100 nm with a 10 nm shell.

It is apparent that the plasmon-derived resonance of silver nanoshells is only slightly stronger (˜10%) than the corresponding gold nanoshell resonance, and that the silver nanoshell resonance appears at a shorter wavelength (˜100 nm in this example) than that of the analogous gold nanostructure. We can also anticipate additional structure in the silver nanoshell spectral response, due to an enhanced contribution of the higher order multipole resonances to the total response of the nanoshell, which contributes to the overall extinction at shorter wavelengths than the lowest order dipole resonance.

Although the plasmon peaks for metals other than gold and silver are not as favorable for optical applications, each of these metals have other properties which could make these particles worth studying. For example, the conductivity, electron transport properties, magnetism, catalytic properties, and reactivity may all be dependent on the core/shell geometry.

The calculations were based on the following method.

A vector based function formalism developed by Sarkar, as described in D. Sarkar and N. J. Halas, Phys. Rev. 56, 1102 (1997), was used to describe the light interaction with these metal nanoshells. This formalism expresses the extinction cross-section as an infinite series. The electric field is expressed as

$$E = {\sum }_{N = 1}^{∞} {a}_{N} M + {b}_{N} N$$

This is a central equation of Mie theory.

The calculated extinction, scattering, and absorption cross-sections are

$${σ}_{ext} = \frac{2 π}{{\vert k \vert}^{2}} {\sum }_{N = 1}^{∞} ( 2 N + 1 ) Re \{ {a}_{N} + {b}_{N} \}$$

$${σ}_{sca} = \frac{2 π}{{\vert k \vert}^{2}} {\sum }_{N = 1}^{∞} ( 2 N + 1 ) ( {\vert {a}_{N} \vert}^{2} + {\vert {b}_{N} \vert}^{2} )$$

$${σ}_{abs} = {σ}_{ext} + {σ}_{sca}$$

Each term in the series was related to a physical oscillation mode of the electrons in the nanoshell. The first term in the series represents the dipole oscillation, the second term represents the quadrupole, and so on. The calculated spectrums were computed to an accurate degree by taking in the first five terms in the series.

One of ordinary skill in the art will understand the geometrical dependence on the metal nanoshells by examining the polarizability of a core shell system.

$$α = 4 π {R}_{s}^{3} {ϵ}_{0} \frac{( {ϵ}_{s} - {ϵ}_{m} ) ( {ϵ}_{c} + 2 {ϵ}_{m} ) + {( {R}_{c} / {R}_{s} )}^{3} ( {ϵ}_{c} - {ϵ}_{s} ) ( {ϵ}_{m} + 2 {ϵ}_{s} )}{( {ϵ}_{s} + 2 {ϵ}_{m} ) ( {ϵ}_{c} + 2 {ϵ}_{m} ) + {( {R}_{c} / {R}_{s} )}^{3} ( {ϵ}_{c} - {ϵ}_{s} ) ( 2 {ϵ}_{m} - {ϵ}_{m} )}$$

In this equation, Rs is the total radius of the particle, Rc is the radius of the core particle, and εs, εm, and εc are the dielectric of the shell, medium, and core, respectively. The core/shell dependence is apparent in the Rc/Rs terms in the polarizability.

Broadening Mechanisms

There are two main broadening mechanisms in metal nanoshells. The first being size distributions in the cores and shells. The second is related to the mean free path of the electrons. Typically, the mean free path of electrons is greater than the thickness of the shell. For example, the mean free path of electrons in bulk silver is 54 nm. This shows itself as a broadening mechanism that must be taken into account. This is done by modifying the dielectric function of the metal in the following way:

$$ϵ ( R , ω ) = {( ϵ ( ω ) )}_{exp} + \frac{{ω}_{p}^{2}}{{ω}^{2} + {iωγ}_{bulk}} - \frac{{ω}_{p}^{2}}{{ω}^{2} + iωΓ}$$

Where ε(ω)exp is the experimental dielectric function, ωp is the bulk plasma frequency, γbulk is the bulk collisional frequency, and Γ is the modified bulk collisional frequency given by

$$Γ = {γ}_{bulk} + A \times \frac{{V}_{F}}{a}$$

In this equation, VF is the Fermi velocity of the electrons in the metal, and a is the reduced electron mean free path, or in this case the shell thickness. The parameter A was calculated by a number of different methods to be of the order of unity and was set to one for these calculations. It will be understood that the bulk collisional frequency embodies a number of physical processes such as electron-electron, electron-phonon, and electron-impurity interactions. Additional scattering mechanisms due to the microstructure of the metallic shell may also contribute to the homogeneous broadening but were not taken into account in this model. For the metals described herein, the Drude theory of electrons was used to calculate the bulk collisional and plasma frequencies and Fermi velocities for the various metals. The Drude theory of metals is described in, for example, N. W. Ashcroft and N. Mermin, Solid State Physics (Harcourt, Fort Worth, 1976).

To model the shells, an extensive library of computer routines was used to calculate the optical efficiencies (cross-section/physical cross-section) as a function of wavelength. These routines implement the foregoing equations.

### EXAMPLE 9

This is a comparative example. This method was performed utilizing a deposition protocol previously reported, for the purpose of deposition of silver on immunogold, by Zsigmondy, as described in Kreibig and M. Vollmer, Optical Properties of Metal Clusters, Springer-Verlag, 1995, pg. 221, hereby incorporated herein by reference.

Gold-decorated silica particles obtained as in Example 4 were mixed with 4 ml of a 0.15 mM solution of fresh silver nitrate (AgNO₃) and stirred vigorously. At this point the solution was clear. A small amount (150 μL mL) of 37% formaldehyde was added to begin the reduction of the silver onto the gold particles on the surface of the silica particle. The solution was a dull gray color, indicating lack of formation of a silver shell.

### EXAMPLE 10

This is a comparative example. This method was performed utilizing a deposition protocol previously reported, for the purpose of deposition of silver on immunogold, by Dansher, in Danscher, G. Histochem. 1981, 71, 177, hereby incorporated herein by reference.

Varying amounts of gold-decorated silica, obtained as in Example 4, were added to 1.2 mL Acacia (500 mg/L) with a 0.2 mL buffer solution (1.5M citric acid, 0.5M sodium citrate, pH=3.5) and 0.3 mL silver lactate (37 mM in water). Then 0.3 mL hydroquinone (0.52M in water) was added while stirring vigorously. Hydroquinone was used as the reducing agent, while the citrate solution and the Acacia as used to stabilize the silver ions and slow down the kinetics of the silver reduction.

A TEM image of a representative particle produced by this process is shown in FIG. 7(a). It can be seen that the used of this method results in the growth of needle-like silver “spikes” onto the silica nanoparticle surface, in addition to a deposition of Ag that coats the surface in a non-uniform manner.

The optical extinction spectra of these nanoparticles for varying degrees of silver deposition are also shown in FIG. 7(b). In these broad and relatively featureless spectra, a very weak plasmon-like feature appears to shift towards longer, then shorter wavelengths as the amount of silver deposited on the nanoparticle surface is increased. Although this spectral behavior is likely to be related to an increasing thickness of metal on the nanoparticle surface, the inventors believe that the overall irregular morphology of the silver deposited on the nanoparticle surfaces by this method makes a comparison with Mie scattering theory intractable for these nanoparticles.

### EXAMPLE 11

This is a comparative example. This method is a based on previously reported recipe, for the purpose of deposition of silver on immunogold given by Burry, as described in Burry, R. W.; Vandre, D. D.; Hayes, D. M. J. Histochem, and Cytochem, 1992, 40, 1849, hereby incorporated herein by reference.

Gold-decorated silica was mixed with 2 mL of silver nitrate (0.17 mM) under vigorous stirring. This was followed by the addition of 100 μL of an n-propyl gallate (NPG) solution and 10 μL of NH₄OH (4.7 mM). The NPG solution was prepared by the addition of 15 mg NPG dissolved in 250 μL of ethanol and then diluted to a total volume of 5 mL with distilled water.

Variations in the amount of silver nitrate available for deposition led to particles with differing optical extinction spectra (FIG. 8(a)). The morphology of the deposition method in this case is quite “bumpy”, more characteristic of aggregated silver colloid attached to the nanoparticle surface than of a continuous silver layer (FIG. 8(b)).

Indeed, the extinction spectra do not show even qualitative agreement with what would be anticipated for a nanoshell optical response. A competing reaction with this deposition is the formation of silver colloid in solution. Preparation of these types of nanoparticles therefore is facilitated by the separation of the larger nanoparticles from the silver colloid by centrifugation. The removal of silver colloid can be followed spectroscopically through the decrease in the silver colloid resonance at ˜300 nm (FIG. 8(a)).

As more metal is deposited on the surface of the silica particle the magnitude of the extinction spectrum increased and the plasmon resonance began to shift to longer wavelengths (FIG. 8(a), spectra 3 and 4). FIG. 8 also shows spectral evidence of the formation of larger silver colloid (˜10 nm diameter) present in solution in the form of a shoulder located around 380 nm, also evident in the TEM images of the products of this reaction (not shown). The density of the larger silver colloid formed in this reaction was similar enough to the silver/silica nanoparticles formed that separation by centrifugation proved exceedingly difficult.

### EXAMPLE 12

This is a comparative example.

Gold-decorated silica particles obtained as in Example 4 were mixed with 0.15 mM solution of fresh silver nitrate (AgNO₃) and stirred vigorously. A small amount of a reducing agent and an optional surfactant were added to the solution. The reducing agent was selected from among Sodium Borohydride, n-propyl gallate, hydroxylamine hydrochloride, UV light, and oleic acid. The surfactant was selected from among polyvinyl alcohol, Acacia (commercial), polyvinyl propanol, Brij 92, Brij 97 (commercial), sodium citrate, potassium carbonate, and tributal phosphate. This method was repeated, using various of the reducing agents and surfactants. In each case, silver shells did not formed, as evidenced by TEM measurements and UV-visible spectra.

### EXAMPLES 13-15

Surface Enhanced Raman Scattering

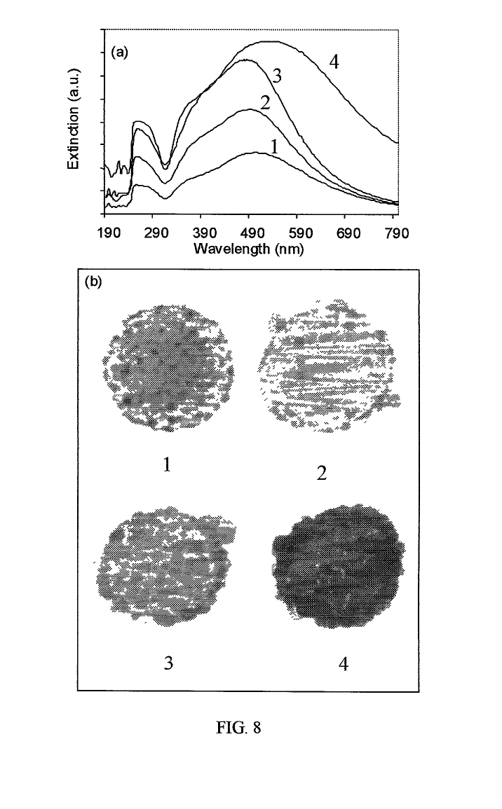

For the purposes of this experiment, p-mercaptoaniline (p-MA or 1,4-aminothiolphenol) was chosen as the analyte. The Raman spectrum of 100 mM solution of p-MA in ethanol, with the ethanol signal subtracted, in shown in FIG. 9. This molecule was chosen because of its previously reported large Raman cross-section and because it has a thiol that can link with the metal surface. The major peak at 1598 cm-1 can be correlated with the asymmetric stretching of the carbon ring. The peak at 1085 cm-1 corresponds to an aromatic ring vibration having some C—S stretching character. Although the 380 cm-1 peak is currently unidentifiable, peaks in this region typically correspond to wagging modes in aromatic rings. The sulfur bond attaches to the surface leaving the amine group free to interact with other molecules of interest. This could be used as a baseline to scale SERS contribution from an absorbate linked to the surface via the amine group.

Small quantities of p-MA were added to silver nanoshell and silver/silica substrate solutions in water to investigate the SERS effect. The enhancement factors were calculated by comparing the peak heights of the 1079 cm-1 mode of the spectrums to 100 mM spectrum, and scaling with the concentration of the solution.

In Examples 13-14 described below, silvering techniques were used to grow silver shells and chemically deposit silver onto gold-decorated Stöber particles. Molecules of p-MA were absorbed onto the surface of these particles for the purpose of surface enhanced Raman scattering. The resultant enhancement gives rise to factors on the order of 1.0×10⁶ and 400,000 in Examples 13 and 14, respectively. The surface roughness of the Raman substrate contributes dramatically to the Raman enhancement as shown by classical electromagnetic enhancement theory, as described in Example 15.

The present inventors believe that this work represents the first Raman enhancement using colloidal silver particles in solution at 1.06 microns. This gives the advantage of the reduction of photo-induced degradation of samples and eliminates sample florescence. Raman spectroscopy in the infrared is accompanied by a λ⁻⁴ decrease in sensitivity (where λ is the wavelength of the incident light, therefore necessitating an enhancement method.

### EXAMPLE 13

Raman Enhancements for Silver Nanoshells

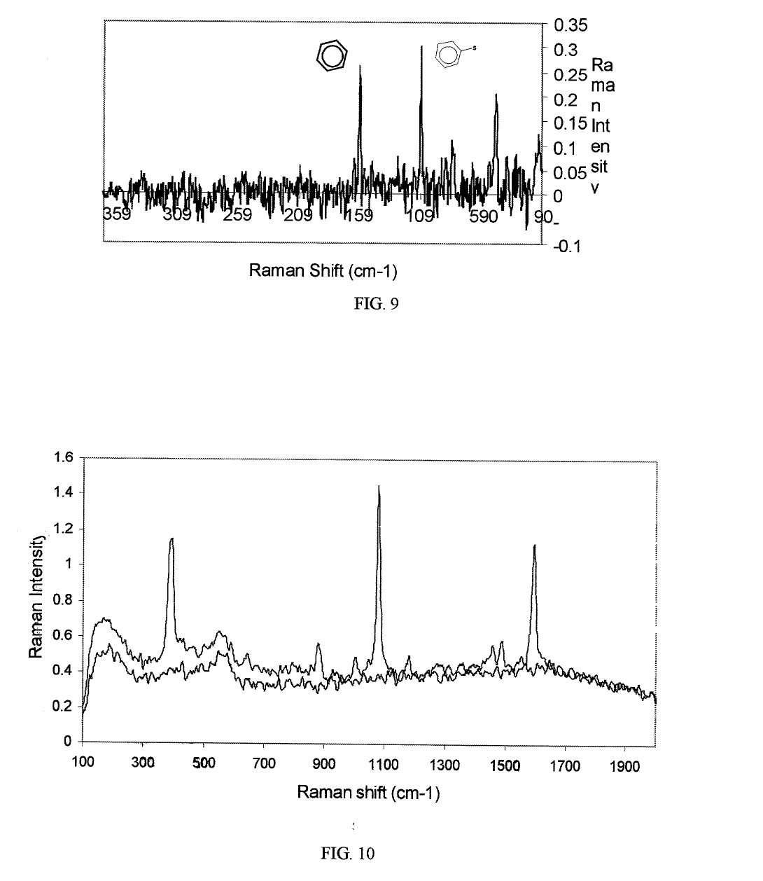

A 1.0 μM solution of p-MA in ethanol was added to a solution of silver nanoshells, obtained as in Example 5, with a core radius of 84 nm and 23 nm thick shell. The concentration of shells was approximately 9.88×10⁸ particles per mL. An average result is shown in FIG. 10. The enhancement factor was on the order of 10⁶ (compared to 100 mM solution of p-MA). The incident excitation wavelength was 1.06 microns (1064 nm).

### EXAMPLE 14

Raman Enhancements for NPG Substrates

This is a comparative example.

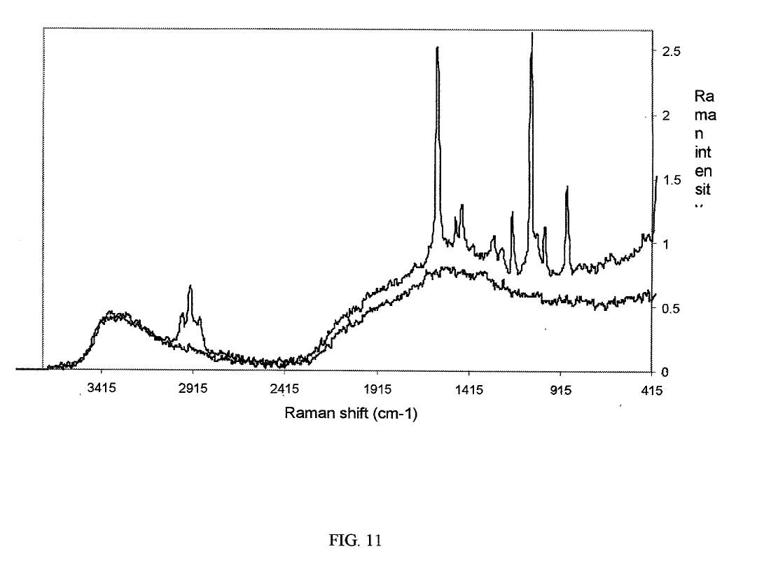

A 10 μM solution of p-MA in ethanol was added to a silver/silica substrate solution, obtained as in Example 11, with a core radius of 128 nm coated with ˜14 nm silver particles. The concentration of Raman active particles in this solution was approximately 8.83×10⁹ particles per mL. The Raman enhancement is shown in FIG. 11. Because the surface roughness varies from particle to particle, enhancements ranged from 200,000 to 600,000 (compared to 100 mM solution of p-MA). This graph gives a typical Raman enhancement factor of ˜400,000.

### EXAMPLE 15

Nanoshells with silica cores and silver shells were fabricated. Silver was used as the shell metal because highly reproducible saturation coverages of the paramercaptoaniline adsorbate molecule were obtainable. A series of silica core-silver shell nanoparticles were constructed using 65 nm and 79 nm cores, upon which silver layers ranging from 5 nm to 20 nm were deposited by an electroless plating method. Following fabrication, UV-Vis spectroscopy and Transmission Electron Microscopy measurements were performed and correlated with Mie scattering theory for each nanoshell sample, to verify core and shell thickness. Comparison with theory showed that deviations in the shell thicknesses of 1-2 nm were present in all nanoshell samples fabricated. Concentrations of the nanoshell solutions were determined by comparing the measured UV-Vis spectra to cross sections calculated from Mie scattering theory and accounting for absorption due to the other nanoshells in solution using Beer's law. Using the total particle radius from the Mie scattering calculations and the calculated concentrations all solutions were normalized to 5.5e¹³ nm²/mL surface area per volume, where e is ln(1). Saturation coverage of paramercaptoaniline onto the Nanoshell samples was obtained consistently when 10 μL of a 10 μM solution of pMA was added to 180 μL of nanoshell solution normalized with respect to nanoparticle surface area. Raman spectra were obtained with a Nicolet 560 FTIR/FT-Raman Spectrophotometer with a 1.0⁶ μm Nd:YAG laser source. An example of a typical Raman spectrum of pMA-adsorbed onto nanoshells in aqueous solution is shown in FIG. 2. The three predominant Stokes modes seen in this emission spectrum (390 cm⁻¹, 1077 cm⁻¹, and 1590 cm⁻¹) all arise from Raman active bending and stretching modes of the benzene ring of the pMA molecule. Anti-Stokes spectra were also obtained for pMA, which consistently showed Boltzmann-type behavior, indicating that optical pumping of the adsorbate by the local field was not occurring. No nanoshell aggregation or flocculation was observed to occur during the experiment.

To determine the Raman response of the adsorbate-nanoshell system as a function of nanoshell core and shell dimensions, the enhanced Raman response of the adsorbate molecules, as shown in FIG. 10, due to the presence of the local electromagnetic field at a nanoshell surface was determined. The field exciting the molecule, E_{ρ}, was taken as the sum of the incident plane wave and the local electromagnetic field on the nanoshell surface as calculated by Mie scattering theory:

E_{ρ}(r′,ωₒ,)=E_{inc}(r′,ωₒ)+Eₛₕₑₗₗ(r′,ωₒ)

The position of the molecule on the nanoshell surface is r′, the position of the observer is r, and the vector between r and r′ is η. The incident frequency is ωₒ and the Stokes shifted frequency is ω. E_{η} was taken at the position of the molecule (r′) and at the incident frequency (ωₒ). The excited molecule was treated as a dipole, oriented normal to the nanoshell surface, with a molecular polarizability, a:

\overline{p}={double overscore (α)}·E_{ρ}(r′,ωₒ)

which radiates at the Stokes frequency with electric field:

$${E}_{dipole} = \frac{1}{{η}^{3}} [ 3 \hat{η} ( \hat{η} \cdot \overline{p} ) - \overline{p} ]$$

The molecular polarizability was taken as unity. The total Raman electromagnetic field at r was the sum of the electromagnetic field of the molecule and the shell response at the Stokes shifted frequency ω:

E_{Roman}(r,ω)=E_{dipole}(r,ω)+Eₛₕₑₗₗ(r,ω)

The electromagnetic field, E_{Raman}, is then calculated for r′ on the nanoshell surface, assuming a monolayer of a molecule covering the surface of the nanoshell and allowing for a coverage of 0.3 nm² per molecule.

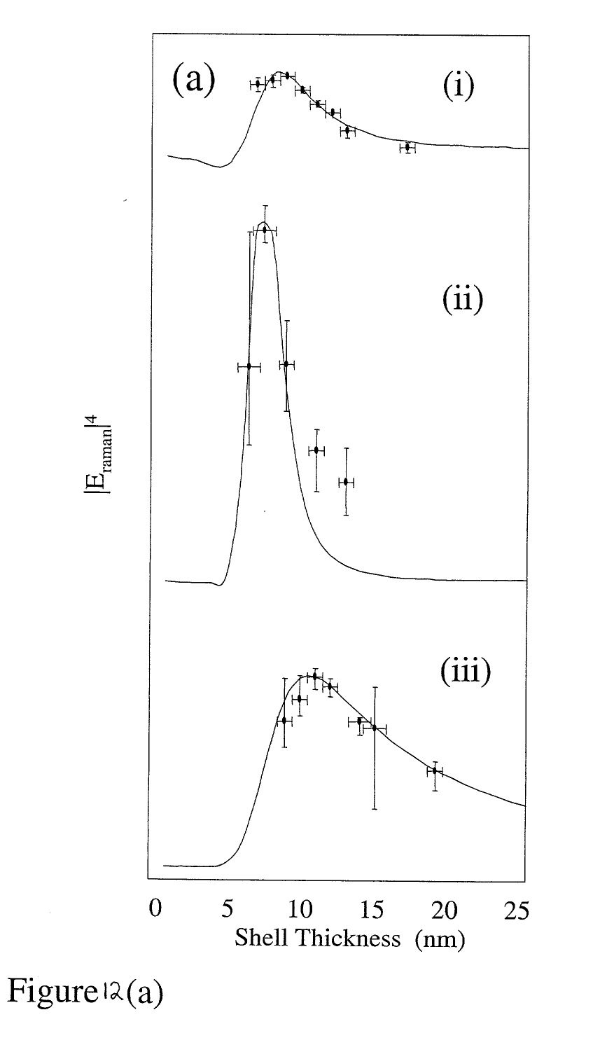

The Raman response for a monolayer of pMA adsorbed onto a nanoshell as a function of core and shell dimensions was calculated. Then, Raman spectra of pMA-adsorbed silver Nanoshells were obtained for (a) 79 nm radius silica core and (b) 65 nm radius silica core, for a range of shell thicknesses varying from 5 nm to 20 nm. This results are shown in FIG. 12, where for each core radius the Raman signal as a function of shell thickness is shown. For each core radius and each Stokes mode, the experimentally measured Raman enhancement matches the theoretical enhancement in a quantitative manner, In particular, the magnitude of the signal, which is due to concentration of adsorbate molecules, orientation with respect to normal at the nanoshell surface, and magnitude of their induced dipole moment, is the only adjustable parameter of this experiment. Error was assessed by (in x) structural uncertainty in shell thickness of 1-2 nm described earlier, and (in y) the standard deviation in the peak magnitudes of the data across five independent data runs. The excellent agreement observed here between experiment and classical theory indicates that, for this system, contributions from addition electromagnetic of chemical effects, such as localized plasmons or resonant enhancement of the adsorbate molecules, is not contributing to the SERS response.

### EXAMPLE 16

The Raman enhancement factor of silver nanoshells was obtained by using a method analogous to Beer's law.

Power_{ABS}=Power_{IN}exp{−σ_{pMA}n_{pMA}d} (1)

The power was compared to the input power for 100 mM solution of pMA, where the path length d is 0.3 cm. A Raman cross-section of 1.4×10⁻²⁵ m² was calculated. Using equation (1), the cross-section calculated from 1 M pMA with nanoshells was 1.50×10⁻¹⁹ m². This gave an enhancement on the order of 10⁶. It is useful to note that the nanoshells have absorption at the shifted Raman wavelength, preventing the Raman scattered light from reaching the detector. That can be calculated from Mie scattering theory and included as:

Power_{ABS}=Power_{IN}exp {−σ_{pMA}^{SERS}n_{pMA}d+σₛₕₑₗₗ(ωₛ)nₛₕₑₗₗd }

This leads to a σ^{SERS} of pMA of 4×10⁻¹³ m² and an enhancement factor of 10¹².

### EXAMPLE 17

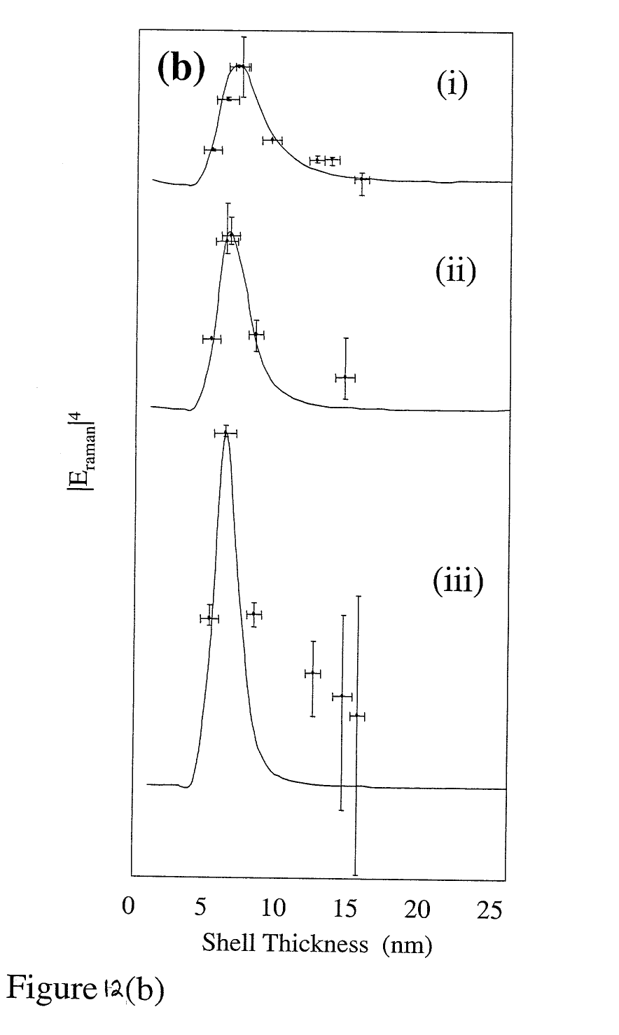

Silica cores were made as described in Example 1. They were centrifuged and resuspended in water. The solution of cores was mixed with tin chloride. A TEM image of one of the functionalized particles is shown in FIG. 13.

### EXAMPLE 18

Previously made Stöber particles were dispersed in a 50/50 methanol and water mixture that is ˜1% silica by volume. CF₃COOH (0.504 mL) and SnCl₂ (0.22 g) were added to 40 mL of a 50/50 mixture of water and methanol. This made a 0.072M and 0.029M solution of CF₃COOH and SnCl₂, respectively. 1 mL of silica solution is added to 9 mL of Sn solution and allowed to react for at least 45 minutes.

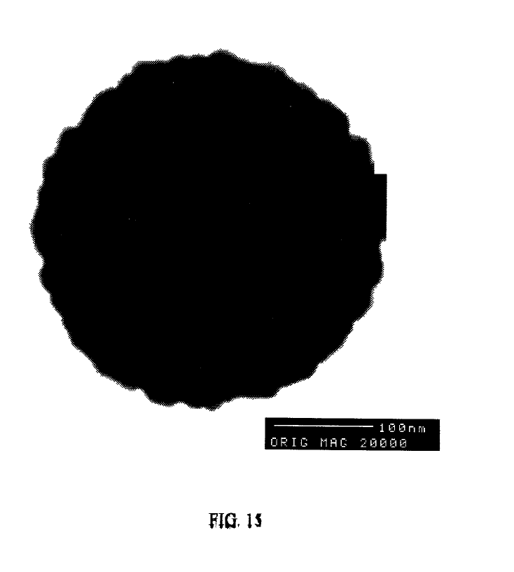

This solution was then centrifuged (at least twice) and redispersed in water. This served as a new seed solution. As an example, 75 μL of this seed solution with 8 mL of 0.206 mM solution of AgNO₃ and 50 μL of 30% formaldehyde was allowed to stir in a beaker for ˜1 min. Then 100 μL of ammonium hydroxide was quickly added to the solution. A Uv/Visible spectrum of the resultant nanoshell is shown as the black line in FIG. 15. The red line is the Mie Theory calculated fit of a 105 nm radius silica core with a 13 nm silver shell.

### EXAMPLE 19

Tin functionalized silica cores were made as described in Example 17. An aqueous solution of 1.5 mL chloroauric acid (25 mM, aged 1 day), 25 mg potassium carbonate, and 100 mL water was mixed with the tin functionalized cores together with formaldehyde as a reducing agent. A TEM image of one of the gold-coated particles is shown in FIG. 15.

While preferred embodiments of this invention have been shown and described, modifications thereof can be made by one skilled in the art without departing from the spirit or teaching of this invention. It will be understood that, unless otherwise indicated, method steps may be carried out in any order. Further, unless otherwise indicated, methods steps may be carried out concurrently. The embodiments described herein are exemplary only and are not limiting. Many variations and modifications of the system and apparatus are possible and are within the scope of the invention. Accordingly, the scope of protection is not limited to the embodiments described herein, but is only limited by the claims that follow, the scope of which shall include all equivalents of the subject matter of the claims.

What is claimed is:

1. A method of making a nanoshell, said method comprising:
(a) providing at least one substrate particle;
(b) treating the substrate particle with a solution of ions of a precursor metal selected from the group consisting of tin and titanium so as to form a functionalized substrate particle; and
(c) forming a complete shell around the functionalized substrate particle by reducing a shell metal onto the functionalized substrate particle, wherein the shell comprises the shell metal.

2. The method according to claim 1 wherein step (b) comprises reducing precursor metal onto the substrate particle.

3. The method according to claim 1 wherein the precursor metal comprises tin.

4. The method according to claim 1 wherein the precursor metal comprises titanium.

5. The method according to claim 1 wherein steps (a)-(c) are each carried out in solution.

6. The method according to claim 1 wherein step (b) is carried out in a water/alcohol solvent.

7. The method according to claim 7 wherein the solvent includes a surfactant.

8. The method according to claim 1 wherein the shell metal is selected from the group consisting of gold, silver, platinum, palladium, copper, iron, and nickel.

9. The method according to claim 8 wherein the shell metal comprises gold.

10. The method according to claim 8 wherein the shell metal comprises silver.

11. The method according to claim 8 wherein the shell metal comprises platinum.

12. The method according to claim 8 wherein the shell metal comprises copper.

13. The method according to claim 8 wherein the shell metal comprises palladium.

14. The method according to claim 8 wherein the shell metal comprises iron.

15. The method according to claim 8 wherein the shell metal comprises nickel.

16. The method according to claim 1 wherein the nanoshell has a plasmon resonance.

17. The method according to claim 16 wherein the plasmon resonance has a maximum at a wavelength between about 400 nm and about 2000 nm.

18. The method according to claim 17 wherein the wavelength is between about 500 nm and about 1500 nm.

19. The method according to claim 18 wherein the wavelength is between about 500 nm and about 1500 nm.

20. The method according to claim 16 wherein the metal comprises silver.

21. The method according to claim 16 wherein the metal comprises gold.

22. The method according to claim 1 wherein the metal is magnetic.

23. The method according to claim 22 wherein the metal comprises nickel.

24. The method according to claim 1 further comprising attaching at least one Raman active molecule to the nanoshell.

25. The method according to claim 24 wherein the nanoshell enhances scattering of light by the Raman active molecule by an enhancement factor of at least about 50,000.

26. The method according to claim 25 wherein the enhancement factor is at least about 10⁶.

27. The method according to claim 26 wherein the enhancement factor is at least about 10¹².

28. The method according to claim 1 wherein step (c) comprises:
(c1) forming a solution comprising:
the functionalized dielectric substrate particle;
a plurality of shell metal ions; and
a reducing agent.

29. The method according to claim 28 wherein the shell metal is selected from the group consisting of gold, silver, platinum, palladium, copper, iron, and nickel.

30. The method according to claim 28, further comprising:
(c2) raising the pH of the solution sufficiently rapidly to affix a layer of the shell metal to the functionalized substrate particle.

31. The method according to claim 30 wherein the shell metal is selected from the group consisting of silver, copper, and nickel.

32. A method of making a nanoshell comprising:
(a) providing a dielectric substrate;
(b) bonding atoms of a precursor metal selected from the group consisting of tin and titanium to the dielectric layer to form a functionalized substrate; and
(c) forming a complete shell layer by
(c1) contacting the functionalized substrate with a solution containing shell metal ions; and
(c2) mixing a reducing agent with the solution.

33. The method according to claim 32 wherein the shell metal is selected from the group consisting of gold, silver, platinum, palladium, copper, iron, and nickel.

34. The method according to claim 32 wherein the nanoshell has a plasmon resonance.

35. The method according to claim 32 wherein the nanoshell is magnetic.

36. The method according to claim 32 wherein step (c) further comprise:
(c3) mixing a base with the solution so as to create a sufficiently rapid rise in pH that the metal ions reduce onto the functionalized layer to form the metal layer.

37. The method according to claim 36 wherein the shell metal is selected from the group consisting of silver, copper, and nickel.

38. The method according to claim 32 wherein step (b) is carried out in a water/alcohol solvent.

39. The method according to claim 38 wherein the solvent includes a surfactant.

40. A method of making a nanoshell having a plasmon resonance, said method comprising:
(a) providing at least one substrate particle;
(b) reducing tin onto the substrate particle to form a functionalized substrate particle; and
(c) reducing a shell metal onto the functionalized substrate particle effective to form a complete shell comprising the shell metal, wherein the shell metal is selected from the group consisting of silver and gold.

41. The method according to claim 40 wherein the plasmon resonance has a maximum at a wavelength between about 400 nm and about 2000 nm.

42. The method according to claim 41 wherein the wavelength is between about 500 nm and about 1500 nm.

43. The method according to claim 42 wherein the wavelength is between about 500 nm and about 1100 nm.

44. The method according to claim 40 further comprising attaching at least one Raman active molecule to the nanoshell.

45. The method according to claim 44 wherein the nanoshell enhances scattering of light by the Raman active molecule by an enhancement factor of at least about 50,000.

46. The method according to claim 45 wherein the enhancement factor is at least about 10⁶.

47. The method according to claim 46 wherein the enhancement factor is at least about 10¹².
